(19) United States
(12) Patent Application Publication
(10) Pub. No.: US 2010/0092230 A1
(43) Pub. Date: Apr. 15, 2010

(54) Writing tool

(76) Inventor: Chueh-Jan Liu, Taipei (TW)

Correspondence Address: Chueh-Jan Liu, P.O. Box 44-2049, Taipei, 10668, TW

(21) Appl. No.: 12/588,598

(22) Filed: Oct. 21, 2009

Related U.S. Application Data
(63) Continuation-in-part of application No. 12/285,708, filed on Oct. 14, 2008, now abandoned.

(51) Int. Cl. B43K 7/10

(52) U.S. Cl. 401/215

(57) ABSTRACT

A writing tool includes tubular cartridge having a writing head connected to an end thereof and iron-carbon powders sized in nanometer are received in the cartridge. The cartridge is received in a barrel and the writing head extends through a through hole of the barrel. The writing head includes an opening and a magnetic ball is rotatably engaged with the opening so that the iron-carbon powders are attached on the magnetic ball and spread on paper sheets when moving the magnetic ball on the paper sheets.

### BACKGROUND OF THE INVENTION

(1) Field of the Invention

This is a Continuation-In-Part application of the U.S. patent application Ser. No. 12/285,708, filed on Oct. 14, 2008.

(2) Description of the Prior Art

A conventional pencil generally includes a wood case in which an elongate lead is received. The users have to remove part of the wood case to allow the lead to protrude from the wood case to write. The lead has to be kept to be long enough beyond the wood case by removing the wood part frequently. This is not convenient for the users who have to prepare a knife and remove the wood case frequently.

Another conventional pencil is mechanical pencil which includes a pushing mechanism in the barrel so as to push the lead by pressing a button on the top of the mechanical pencil. However, the lead used in the mechanical pencil usually has only 0.5 mm in diameter and is easily broken, this restricts the use of the mechanical lead and wastes a significant amount of the lead.

U.S. Pat. No. 4,960,464 discloses a writing tool which uses ink and the ink includes Ferrous sulfate which is used as catalysis of the Ethylene glycol and Oleic Acid. U.S. Pat. No. 4,634,306 discloses a writing tool which uses metallic glass or amorphous metal as the tip which is characterized in its abrasion resistance.

The present invention intends to provide a writhing tool which includes a tube in which iron-carbon powders are received and magnetic ball is rotatably connected to the head connected to the tube, the iron-carbon powders are attached to the magnetic ball and spread on the sheet when using the writing tool.

### SUMMARY OF THE INVENTION

The present invention relates to a writing tool which comprises a tubular cartridge received in a barrel and the cartridge has a writing head connected to an end of the cartridge and extending through a through hole of the barrel. Iron-carbon powders sized in nanometer are received in the cartridge. The writing head includes an opening and a magnetic ball is rotatably engaged with the opening. The iron-carbon powders are attached on the magnetic ball and spread on paper sheets.

The primary object of the present invention is to provide a writing tool which includes the characters of ball pens and pencils.

It is noted that the paper sheets include rough surfaces which include recesses, gaps or dents such that when the magnetic ball moves over the rough surfaces, the pressure presses the iron-carbon powders onto the paper sheets and the friction force between the iron-carbon powders and the paper sheets is larger than the attractive force between the iron-carbon powders and the magnetic ball, so that the iron-carbon powders are left on the paper sheets.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the cartridge of the writing tool of the present invention;

FIG. 2 is a cross sectional view to show the writing head of the cartridge of the writing tool of the present invention, and

FIG. 3 is a perspective view to show the writing tool of the present invention.

### DETAILED DESCRIPTION OF THE PREFERRED EMBODIMENT

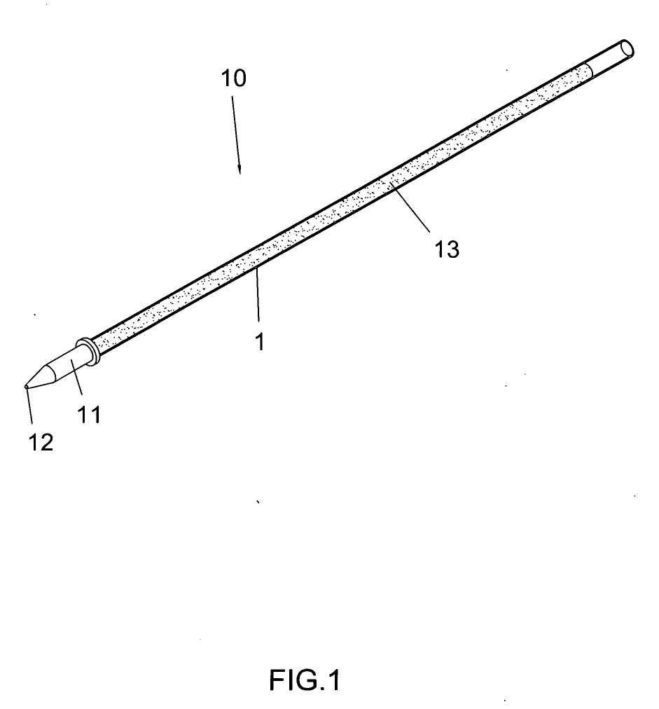

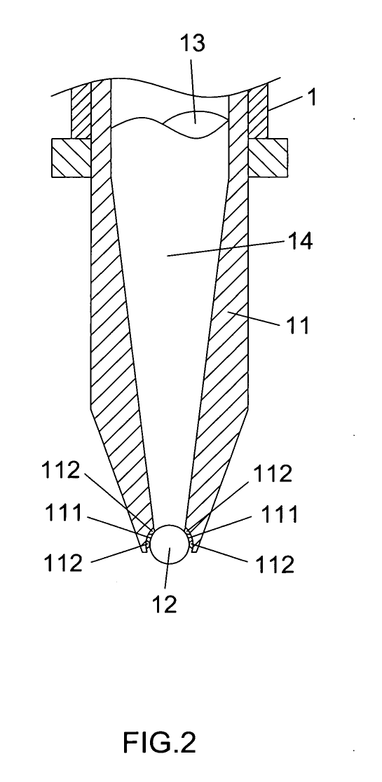

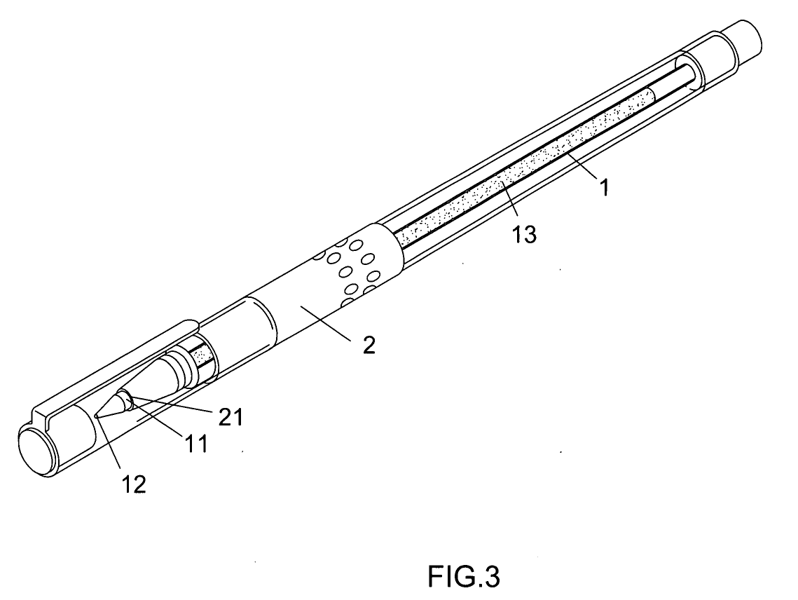

Referring to FIGS. 1 to 3, the writing tool 10 of the present invention comprises a tubular cartridge 1 received in a barrel 2 and the cartridge 1 includes a writing head 11 connected to an end of a tube of the cartridge 1. The writing head 11 extends through a through hole 21 of the barrel 2 and an opening 111 is defined through the writing head 11. Iron-carbon powders 13 sized in nanometer are received in the tube of the cartridge 1. A magnetic ball 12 is rotatably engaged with the opening 111 and a plurality of protrusions 112 extend from an inner periphery of the opening 111 of the writing head 11 such that the magnetic ball 12 is smoothly and rotatably in contact with the protrusions 112. The writing head 11 has a path 14 defined therein which communicates with the opening 111 and the cartridge 1, the path 14 is in a shape of a hopper so as to guide the iron-carbon powders 13 to flow toward the opening 111 where the magnetic ball 12, and the iron-carbon powders 13 can be magnetically attached on the magnetic ball 12.

When using the writing tool 10, the user moves the magnetic ball 12 on the paper sheet and the magnetic ball 12 rotates to spread the iron-carbon powders 13 on the paper sheet along the trace the magnetic ball 12 moves.

It is noted that the paper sheets are made of fibers which include rough surfaces such that recesses, gaps or dents are formed in the rough surfaces of the paper sheets. When the magnetic ball 12 moves over the rough surfaces, the users apply a force to the magnetic ball 12 and the force presses the iron-carbon powders 13 onto the paper sheets. The iron-carbon powders 13 are further affected by Van Der Walls force, electrostatic force and friction force, and enter into the recesses, gaps or dents of the paper sheets. The forces mentioned above between the iron-carbon powders 13 and the paper sheets is larger than the attractive force between the iron-carbon powders 13 and the magnetic ball 12, so that the iron-carbon powders 13 are left on the paper sheets. Furthermore, the attractive force between the iron-carbon powders 13 and the magnetic ball 12 varies along with the distance between the center of the magnetic ball 12 and the iron-carbon powders 13. The iron-carbon powders 13 are attached on the magnetic ball 12 layers by layers in radial direction, the attractive force on the outer layer of the iron-carbon powders 13 will be less than that at the inner layer, so that the iron-carbon powders 13 on the outer layer on the magnetic ball 12 can be left on the paper sheets easily. Along with the rotation of the magnetic ball 12, the iron-carbon powders 13 are added on and on to the magnetic ball 12 so that the iron-carbon powders 13 on the outer layer can be continuously left on the paper sheets.

The writhing tool 10 can be replaced with a new one when the iron-carbon powders 13 are used out, or the iron-carbon powders 13 can be refilled into the tube. By the writing tool 10, the users do not need to remove the wood case as used for the conventional pencils and the pushing mechanism for the mechanical pencils can also be saved.

While we have shown and described the embodiment in accordance with the present invention, it should be clear to those skilled in the art that further embodiments may be made without departing from the scope of the present invention.

What is claimed is:

1. A writing tool comprising:
a tubular cartridge received in a barrel and having iron-carbon powders sized in nanometer received therein, a writing head connected to an end of the cartridge and extending through a through hole of the barrel, the writing head including an opening and a magnetic ball rotatably engaged with the opening, the iron-carbon powders being attached on the magnetic ball and adapted to be spread on paper sheets.

2. The writing tool as claimed in claim 1, wherein the writing head has a path defined therein which communicates with the opening and the cartridge.

3. The writing tool as claimed in claim 1, wherein a plurality of protrusions extend from an inner periphery of the opening of the writing head and the magnetic ball is rotatably in contact with the protrusions.

4. The writing tool as claimed in claim 2, wherein the path is in a shape of a hopper.
